(19) United States
(12) Patent Application Publication
(10) Pub. No.: US 2017/0253322 A1
(43) Pub. Date: Sep. 7, 2017

(54) Split Winglet Lateral Control

(71) Applicant: Google Inc., Mountain View, CA (US)

(72) Inventor: Mark Krebs, Niwot, CO (US)

(73) Assignee: Google Inc., Mountain View, CA (US)

(21) Appl. No.: 15/058,503

(22) Filed: Mar. 2, 2016

(51) Int. Cl. B64C 23/06

(52) U.S. Cl. CPC B64C 23/065

(57) ABSTRACT

A winglet includes a winglet body and a control body. The winglet body includes a first winglet surface arranged opposite a second winglet surface. The second winglet surface is joined to the first winglet surface to form front and trailing edges of the winglet body. The second winglet surface defines a control body seat. The control body is coupled to the winglet body to move between a stowed position seated in the control body seat and a deployed position rotated out of the control body seat. The control body includes a first control surface arranged to face toward the winglet body, a second control surface arranged opposite the first control surface to face away from the winglet body and joined to the first control surface to form a trailing edge of the control body and a control front connecting the first control surface and the second control surface.

### TECHNICAL FIELD

This disclosure relates to split winglet lateral control of an aerial vehicle, such as a plane.

### BACKGROUND

Aircraft generally need control in each of the pitch, roll and yaw axes, conventionally mapping to elevator, aileron and rudder. In traditional aircraft, the elevator and rudder are located on the tail of the aircraft. In very lightweight aircraft, tails themselves are a mass and drag burden. Simultaneously, aircraft with very high aspect ratio main wings make it difficult to reach the appropriate vertical tail volume coefficient due to the very large moment potential in large span wings. Aircraft commonly use winglets to distend tip vortices and recover thrust with less than commensurate weight and wing bending moment penalty.

### SUMMARY

One aspect of the disclosure provides a winglet including a winglet body and a control body. The winglet body includes a first winglet surface arranged to face away from an attached wing and a second winglet surface arranged opposite the first winglet surface to face toward the attached wing. The second winglet surface is joined to the first winglet surface to form a front edge of the winglet body and a trailing edge of the winglet body. The second winglet surface defines a control body seat. The control body is coupled to the winglet body to move between a stowed position seated in the control body seat and a deployed position rotated out of the control body seat. The control body includes a first control surface arranged to face toward the winglet body, a second control surface arranged opposite the first control surface to face away from the winglet body and joined to the first control surface to form a trailing edge of the control body and a control front connecting the first control surface and the second control surface.

Implementations of the disclosure may include one or more of the following optional features. In some implementations, the winglet includes a hinge mounted at a junction of the control front and the first control surface. The hinge may allow rotation of the control body relative to the winglet body. When the control body is in the deployed position, the trailing edge of the control body may be spaced from the trailing edge of the winglet body. When the control body is in the stowed position, the trailing edge of the control body may be substantially coincident with the trailing edge of the winglet body. When the control body is in the stowed position, the first control surface and the second winglet surface may form a substantially continuous surface. In some examples, when the control body is in the stowed position, the second control surface is approximately adjacent to a chord line of the winglet body.

The winglet may include an actuator housed by the winglet body and configured to move the control body between the stowed position and the deployed position. In some implementations, the second winglet surface defines the control body seat as recess complementary to a size and shape of the control body. When the control body is in the stowed position, the second control surface of the control body may be substantially co-planar with the second winglet surface of the winglet body. The second winglet surface may define the control body seat rearward of the front edge of the winglet body and inside a chord line of the winglet body. In some examples, the winglet includes a solar panel disposed on one or more of the first winglet surface, the second winglet surface, or the second control surface.

Another aspect of the disclosure provides a wing assembly including a wing having a proximal end and a distal end, a winglet attached to the distal end of the wing and a control body. The winglet includes a winglet body including a first winglet surface arranged to face away from the wing and a second winglet surface arranged opposite the first winglet surface to face toward the wing. The second winglet surface is joined to the first winglet surface to form a front edge of the winglet body and a trailing edge of the winglet body. The second winglet surface defines a control body seat. This aspect may include one or more of the following optional features. The control body is coupled to the winglet body to move between a stowed position seated in the control body seat and a deployed position rotated out of the control body seat and over the wing. The control body includes a first control surface arranged to face toward the winglet body, a second control surface arranged opposite the first control surface to face away from the winglet body and joined to the first control surface to form a trailing edge of the control body, and a control front connecting the first control surface and the second control surface.

Implementations of the disclosure may include one or more of the following optional features. In some implementations, the winglet includes a hinge mounted at a junction of the control front and the first control surface. The hinge may allow rotation of the control body relative to the winglet body. When the control body is in the deployed position, the trailing edge of the control body is spaced from the trailing edge of the winglet body. When the control body is in the stowed position, the trailing edge of the control body is substantially coincident with the trailing edge of the winglet body. In some examples, when the control body is in the stowed position, the first control surface and the second winglet surface forms a substantially continuous surface. In addition, when the control body is in the stowed position, the second control surface may be approximately adjacent to a chord line of the winglet body.

In some implementations, the winglet further includes an actuator housed by the winglet body and configured to move the control body between the stowed position and the deployed position. The second winglet surface may define the control body seat as recess complementary to a size and shape of the control body. When the control body is in the stowed position, the second control surface of the control body may be substantially co-planar with the second winglet surface of the winglet body. The second winglet may define the control body seat rearward of the front edge of the winglet body and inside a chord line of the winglet body. When the control body is in the deployed position, the control body and the trailing edge of the control body may be located over the wing. In some examples, the winglet includes a solar panel disposed on one or more of the first winglet surface, the second winglet surface, or the second control surface. The wing may further define a wing longitudinal axis and the winglet may define a winglet longitudinal axis. The winglet may be arranged with respect to the wing to have the winglet longitudinal axis substantially perpendicular to the wing longitudinal axis.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a perspective view of an example aircraft.

FIG. 2A is a front view of an example wing and winglet.

FIG. 2B is a perspective view of an example wing, winglet, and a movable control body.

FIG. 2C is a top view of the winglet and the control body shown in FIG. 2B in a deployed position.

FIG. 2D is a top view of the winglet and the control body shown in FIG. 2B in a stowed position.

FIG. 3A is a perspective view of an example solar panel attached to a winglet and control body.

FIG. 3B is a perspective view of an example solar panel attached to a winglet

FIG. 3C is a perspective view of an example aircraft with solar panels on vertical surfaces of the aircraft.

Like reference symbols in the various drawings indicate like elements.

### DETAILED DESCRIPTION

Yaw control of an aircraft using a traditional rudder may be disadvantageous, as the rudder may increase the frontal drag area of the aircraft and may increase the total aircraft weight. Some aircraft may use a split aileron to provide yaw control in place of a traditional rudder. Winglets provide aerodynamic advantages and may allow a wing to be more efficient. This idea presents a means for controlling the yaw of the aircraft with a coordinated yaw roll moment created by a split winglet.

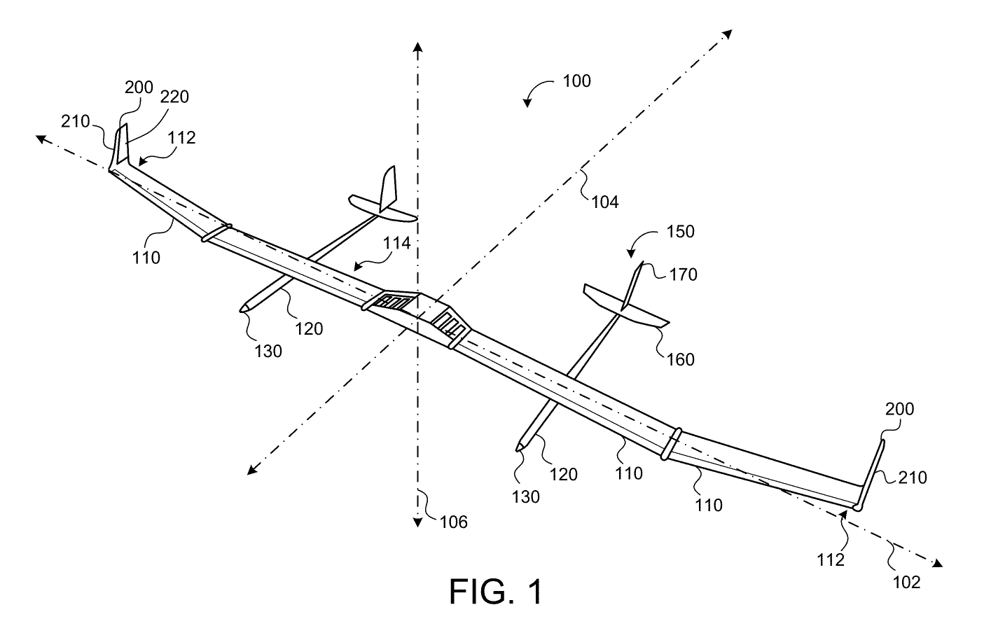

FIG. 1 is a perspective view of an example aircraft 100 defining a pitch axis 102, a roll axis 104, and a yaw axis 106. The aircraft 100 includes a wing 110 or wings 110 to generate lift for powered flight. The aircraft 100 may also include one or more fuselages 120 attached to the wings 110. Each fuselage 120 may be any number of different shapes and may be attached at any locations along the corresponding wing 110. In some examples, the fuselage 120 is an integral structure for the wings 110, or it may be separate from the wings 110. A power plant 130 may be attached to the fuselage 120, wings 110, a tail 150 and/or any part of the aircraft suitable for operation of the power plant 130. The power plant 130 provides a means of driving the aircraft through the air by generating some form of thrust. The thrust may be generated by various means, including but not limited to propellers, fans, expansion of exhaust gasses, heat, airfoil movement, etc. The power plant 130 may be any of the following, including but not limited to, piston engines, electric, ducted fan, jet engines, turboprop engines, pulse jets, rockets, winkle engines, and diesel. In at least one example, the power plant 130 is an electric engine driving a propeller. The tail 150 may be connected to the fuselage 120 and include an elevator 160 and a rudder 170. The elevator 160 may be located in the wing 110 and be combined with ailerons. The rudder 170 may be a stationary vertical control body to provide stability around the yaw axis 106. The rudder 170 may be a movable surface to provide directional control around the yaw axis 106 or a combination of a movable and stationary surface. The elevator 160 generates movement of the aircraft about the pitch axis 102. The elevator 160 may be mounted on the tail 150, or it may be mounted on any appropriate location to generate motion around the pitch axis 102. Ailerons and/or the rudder 170 may generate motion around the roll axis 104. The wing 110 may include a winglet 200 attached to a distal end 112 of the wing 110 opposite the proximal end 114 of the wing. The winglet 200 serves to provide aerodynamic advantages and the combination of a control body 220 on the winglet 200 allows for the aircraft 100 to be rotated around the yaw axis 106.

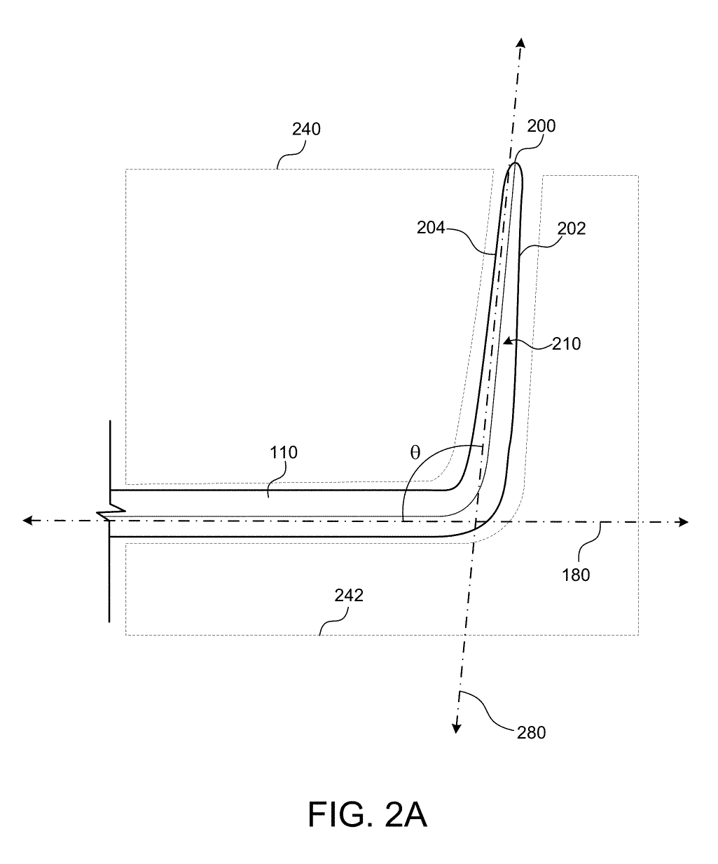

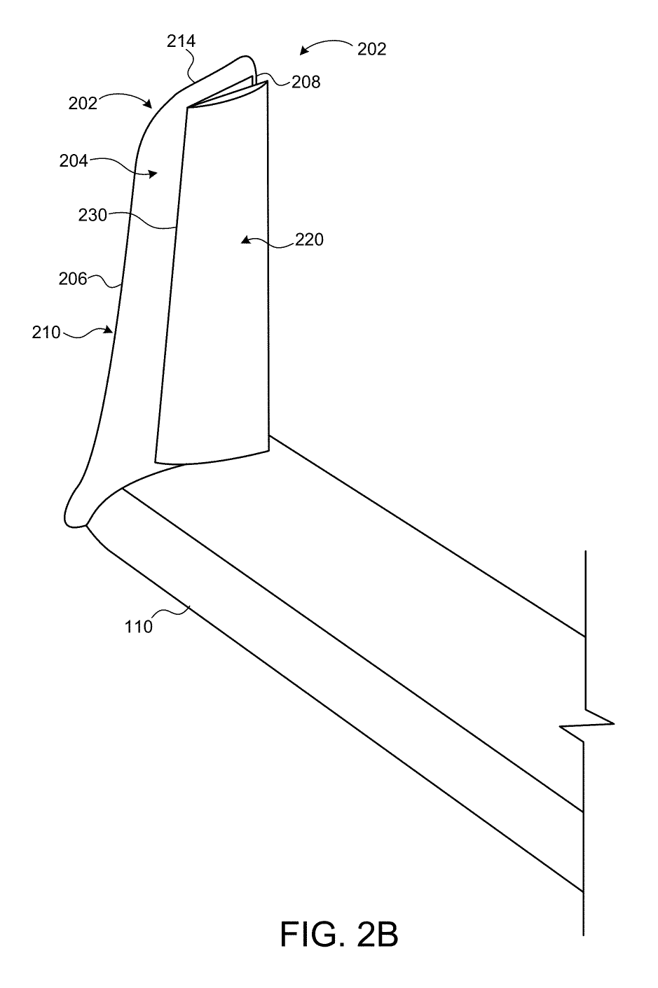

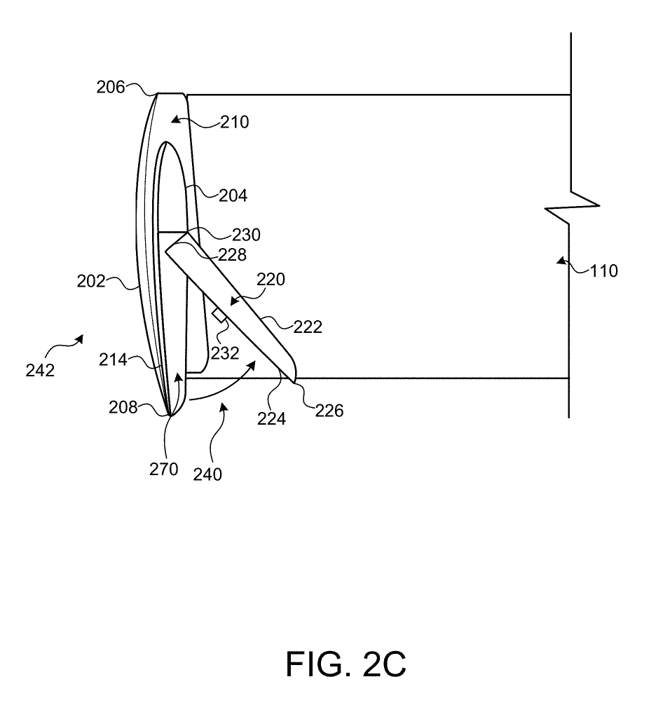

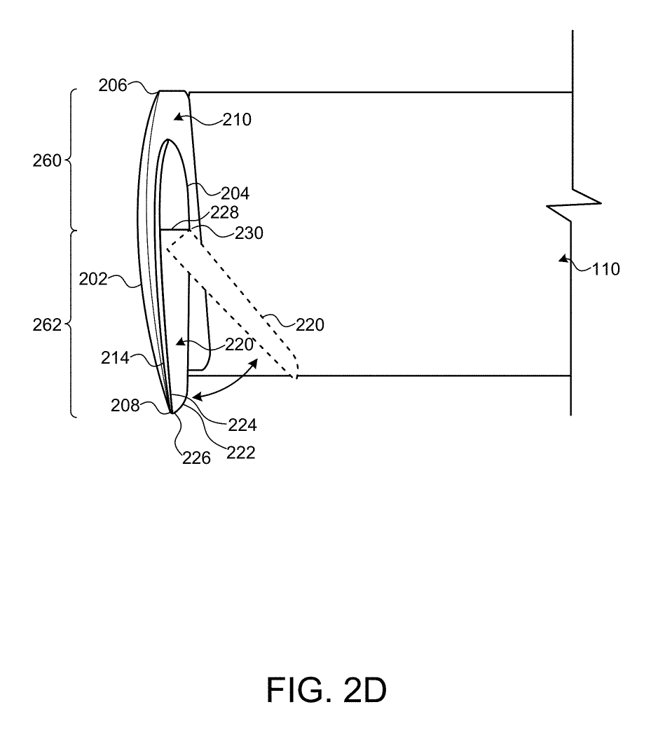

FIG. 2A is a front view of the winglet 200 attached to the wing 110. The winglet 200 is attached to the distal end 112 of the wing 110 and includes a first winglet surface 202 facing away from the wing 110 and a second winglet surface 204 opposite the first winglet surface 202 and facing towards the wing 110. In some examples, the second winglet surface 204 is adjacent to the wing 110. In other examples, the second winglet surface 204 is on the same side of the winglet 200 as the wing 110. The second winglet surface 204 may be joined to the wing 110. The first winglet surface 202 and second winglet surface 204 partially define a winglet body 210. The winglet body 210 may include some structure, give support to the surfaces, and allow for attachment. The winglet body 210 and winglet 200 may be used interchangeably. As air travels over the wing 110, the wing 110 alters the pressure of the air to create a pressure differential, thus creating lift. Generally, in an upright flying aircraft 100, a low pressure region 240 is located above the wing 110 and inside the winglet 200 and a high pressure region 242 is located below the wing 110 and outside the winglet 200. Depending on the shape and angle of attack for the winglet 200, the low pressure region 240 and high pressure region 242 may be reversed. Moreover, the high pressure region 242 and low pressure region 240 may be gradient and blended having no defined ending area. The high pressure region 242 and low pressure region 240 may extend almost to the surface of the wing 110 or winglet 200, but due to a boundary layer of static or slower moving air, the pressure of the high pressure region 242 and/or low pressure region 240 may be different immediately next to the boundary layer. In some examples, the wing 110 includes a wing longitudinal axis 180 which extends along the length of the wing 110. The winglet 200 includes a winglet longitudinal axis 280 which extends along the length of the winglet 200. The wing longitudinal axis 180 and winglet longitudinal axis 280 are arranged at an angle θ with respect to each other. In some examples, the angel θ is 90 degrees±30 degrees.

FIG. 2B shows the wing 110, the winglet 200, and the control body 220. The control body 220 may be mounted or coupled to a hinge 230. The hinge 230 may be mounted to the second winglet surface 204 of the winglet 200. A chord line 214 extends from the front edge 206 of the winglet 200 to the trailing edge 208. The chord line 214 may be dependent on the shape of the first winglet surface 202 and the second winglet surface 204 that forms the airfoil of the winglet 200. The chord line 214 may not be a straight line and may be curved. Also, the first winglet surface 202 of the winglet 200 may not be part of the control body 220. The control body 220 may be shaped to conform to the shape of the airfoil or winglet 200 or it may be a different shape. The airflow travels along the surface of the winglet 200 from the front edge 206 to the trailing edge 208. When the control body 220 deploys from the second winglet surface 204 of the winglet 200 to a deployed position, control body 220 extends into the airflow creating drag at the winglet 200. The hinge 230 can be any mechanism that permits sufficient movement of the control body 220, including but not limited to, piano hinges, internal hinges, external hinges, and/or pivot hinges, etc. In some examples, part of the control body 220 extends forward of the hinge 230 in the direction of the airflow to allow for aerodynamic balancing of the control body 220. The control body 220 may be actuated by any suitable actuator 232, including but not limited to, cables, hydraulic actuators, electrical actuators, linear motors, and/or rotary motors, etc. The control body 220 may be actuated by a physical control input or it may be electrically controlled as in fly-by-wire or computer control.

FIG. 2C shows a top view of the winglet 200 and the control body 220 in the deployed position. The control body 220 rotates about the hinge 230. The rotation does not need to be linear or parallel to the first winglet surface 202 and may move in any direction suitable to extend the control body 220 into the airflow. The control body 220 includes a first control surface 222 located towards the wing 110 and may be coplanar or continuous to the first winglet surface 202. In some examples, the first control surface 222 is adjacent to the wing 110. In other examples, the first control surface 222 is on the same side of the winglet 200 as the wing 110. The first control surface 222 may be joined partially to the wing 110. One edge of the first control surface 222 connects to the second control surface 224 forming a trailing edge 226. The first control surface 222 and the second control surface 224 may be substantially opposite each other. In some examples, the first control surface 222 and the second control surface 224 are different shapes. Opposite the trialing edge 226 is the a front edge 228, which connects the first control surface 222 to the second control surface 224, forming the control body 220. The hinge 230 may attach to the control front 228. In some examples, the hinge 230 is located along the control front 228, the first control surface 222, the second control surface 224, or contained within the control body 220 itself. Prior to deployment, the control body 220 may be seated in a control body seat 270 located in the winglet body 210. The control body seat 270 may be a recess which may be shaped for the control body 220 to seat into allowing for a lower drag position than the deployed position. In the deployed position, the control body 220 extends away from the first winglet surface 202 and towards the wing 110. The deployment of the control body 220 interrupts the airflow over and around the wing 110 creating an inverse pressure gradient or low pressure region 240 behind the control body 220. The first winglet surface 202 remains substantially continuous and does not allow the air of high pressure region 242 to penetrate or mix with the air in the low pressure region 240 above the wing 110. This low pressure gradient or low pressure region 240 may be generally over the top of the wing 110, resulting in drag. The drag created by the low pressure region 240 results in a moment about the wing 110 and creates motion of the aircraft in the yaw axis 106.

FIG. 2D shows the winglet 200 with the control body 220 in a stowed position. The control body 220 rotates toward the first winglet surface 202, reducing the drag created by the control body 220 and the rotation about the yaw axis 106. The winglet 200 includes a leading portion 260 and a trailing portion 262. The leading portion 260 extends from approximately the hinge 230 or control front 228 to the front edge 206. The trailing portion 260 extends from approximately the hinge 230 or control front 228 to the trailing edge 208. When the control body 220 is stowed, the second winglet surface 204 and the first control surface 222 form a generally continuous surface that allows for the aerodynamic advantages of the winglet 200. The second control surface 224 may be adjacent to the control body seat 270 in the stowed position. In some examples, the winglet 200 is angled to create additional thrust due to the pressure differential between the low pressure region 240 and the high pressure region 242.

One advantage of this configuration is that the low pressure region 240 creates drag without adding additional lift due in part to the containment of the low pressure region 240 on the bottom by the wing 110, and this configuration does not create uncoordinated motion about the roll axis 104. This allows the aircraft 100 to generate a motion about the yaw axis 106 without a substantial change in the roll axis 104, effectively decoupling the yaw and roll motion. This may be advantageous for aircraft 100 that need to remain relatively level while orbiting. This may result in a reduction in the amount of movement required for certain payloads, thus reducing the weight of the aircraft 100 and increasing flight time or efficiency. For example, with a beam communication link, allowing the aircraft 100 to remain relatively level while orbiting a location reduces the amount of motion required for the transmitter to move in the roll axis 104, resulting in less weight. In some examples, the gimbal or motion system is eliminated due to the consistent wings level nature of the turn created about the roll axis 104.

In aircraft 100 with powerful aileron control about the roll axis 104, the wing 110 upper and lower surfaces may have lift coefficients matched to their (disparate) span wise flowfield velocities. When a large aileron is activated the upward deflecting aileron enters the low pressure region 240 and the downward defecting aileron enters the high pressure region 242, resulting in a disproportionate amount of drag at each ends of the wings 110. The winglet 200 may deploy the control body 220 to counter act the disproportionate drag, which allows for better roll control without upsetting the aircraft 100 through the use of a rudder 170. For aircraft 100 with weak roll control, such as aircraft with high wing dihedral, the lateral control must generally be strong enough to deliver sufficient beta or roll moment about the roll axis 104 to overcome the tendency of the wing 110 to return to level from dihedral. The long moment arm between a center of the aircraft 100 (e.g., the yaw axis 106) and the winglet 200 and draft created by the control body 220 increases the motion about the yaw axis 106 without additional structure. In high aspect ratio aircraft 100, such as tailless aircraft or flying wings, the winglet 200 and control body 220 allows a high deferral or high stability wing 110 to be used while still providing adequate control in the yaw axis 106 due to the large moment. This is advantageous by allowing for the elimination of part and/or all of the fuselage 120, the elevator, 160, the rudder 170, or tail structure, thus providing weight savings and increased stability of the aircraft 100.

Unlike a winglet 200 where when the control body 220 is deployed there is a hole or void allowing air to pass between the high pressure region 242 and low pressure region 240 through the winglet 200 that creates a change in lift in for the wing 110, the winglet 200 and the control body 220 in the examples shown does not increase the lift of the wing 110 significantly or create a significant uncoordinated motion along the roll axis 104. In some examples, the winglet 200 and the control body 220 may decrease the lift of the wing 110 resulting in a coordinated roll moment about the roll axis 104. Unlike a control body 220 that deflects outward away from the wing 110 that may generate lift due in part to an increase in the low pressure region 240 similar to an increase in wingspan, this design does not substantially result in an increase in lift for the wing 110 or result in uncoordinated motion along the roll axis 104. Further, unlike a control body 220 that is split or multiple control bodies 220 that deflect outwardly away from the wing 110 and inwardly towards the wing 110 resulting in an increase in lift similar to an increase in wingspan, this design does not create significant additional lift of the wing or uncoordinated motion along the roll axis 104. Unlike a split aileron, which controls motion about the roll axis 104 and yaw axis 106 by requiring movement of two control surfaces individually, the winglet 200 only requires one control body 220 to be moved to obtain yaw control and does not interfere with roll control allowing for a simpler and weight advantageous system. Unlike a split flap, which controls total wing lift and drag on both sides of a wing 110, the winglet 200 only creates drag and decreases lift, allowing rotation about the yaw axis 106 and does not create aircraft 100 instability as would a split flap system operated non-symmetrically. Further, unlike split flaps, split ailerons, ailerons, flaps, speed brakes, and/or dives brakes, etc. used to increase the total drag of an aircraft 100, these do not create an uncoordinated motion about the yaw axis 106 intentionally and non-symmetrical operation would result in aircraft instability, the winglet 200 and control body 220 provide control about the yaw axis 106 and allow for non-symmetrical operation without causing aircraft 100 instability.

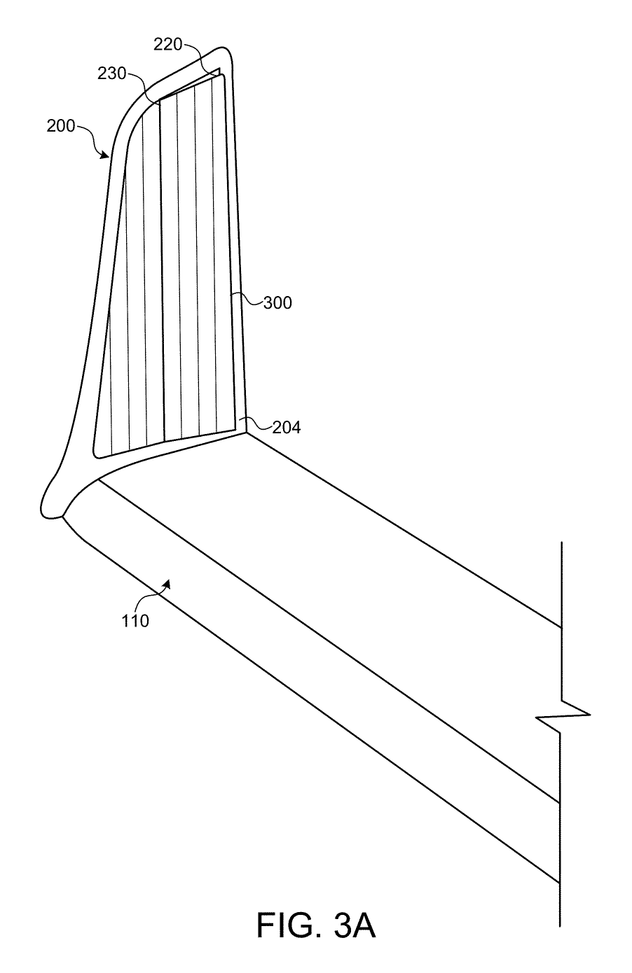

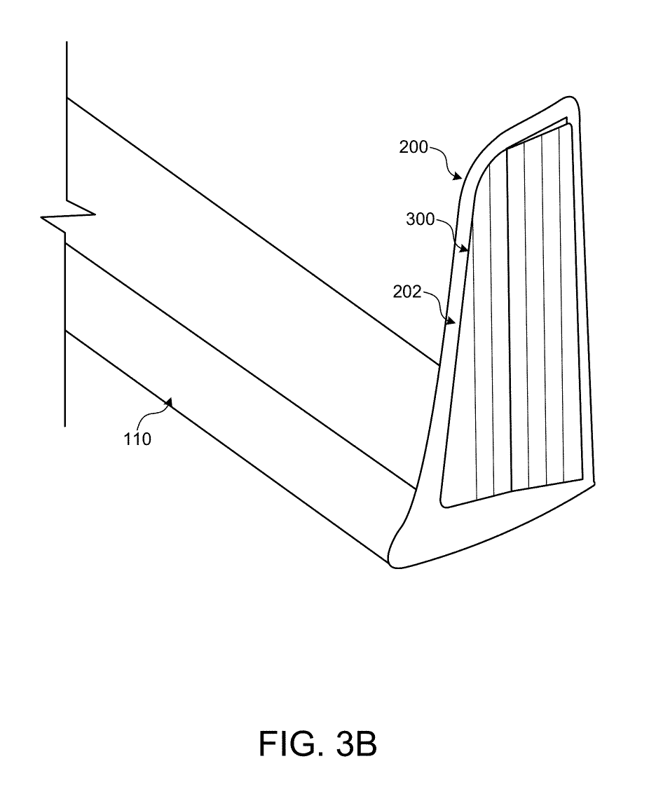

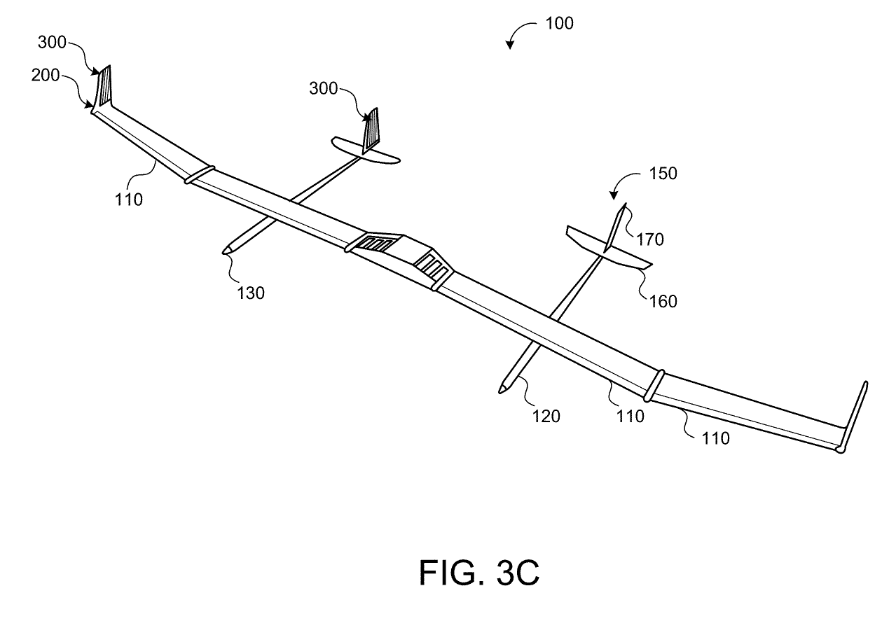

FIG. 3A shows a solar panel 300 attached to a winglet 200 and control body 220. The solar panel 300 is any suitable form of a solar panel 300 for collecting sunlight and converting it into energy. In some configurations, the solar panel 300 delivers electrical energy to the power plant 130, which may store energy in a battery system to later drive the power plant 130 and/or run electronic systems and/or communication systems of the aircraft 100. The solar panel 300 may cover some or a substantial part of the second winglet surface 204 and/or the first control surface 222.

FIG. 3B shows the solar panel 300 attached to the winglet 200. In some examples, the solar panel 300 is incorporated into the first winglet surface 202 of the winglet 200. In additional examples, the solar panel 300 only covers part of the first winglet surface 202 of the winglet 200.

FIG. 3C shows an aircraft 100 with solar panels 300 on vertical surfaces of the aircraft 100. Solar panels 300 may be mounted on the second winglet surface 204 of the winglet 200, the first winglet surface 202 of the winglet 200, the rudder 170, and/or any vertical surface. Mounting the solar panel 300 on a vertical surface, such as the second winglet surface 204 of the winglet 200, the first winglet surface 202 of the winglet 200 and/or the rudder 170, provides an advantage for capturing light during times of the day when the sun is at a lower angle. In some examples of long duration aircraft 100, this results in a significant improvement in total solar energy captured at times of day when the sun is at a lower angle relative to the aircraft wings 110. Unlike an aircraft 100 that has solar panels 300 on the top surface of the wings 110 or horizontal surfaces, having solar panels 300 the vertical surfaces of the aircraft 100 increases a total surface exposed to the sun for solar energy collection during periods when solar panels 300 on horizontal surfaces of the aircraft 100 would be less effective. Considering that the sun is rarely directly over the top of the aircraft 100 with no angle, mounting of solar panels 300 on the winglet 200 and/or vertical surfaces provides an advantage in total solar collection and energy obtained.

A number of implementations have been described. Nevertheless, it will be understood that various modifications may be made without departing from the spirit and scope of the disclosure. Accordingly, other implementations are within the scope of the following claims.

What is claimed is:

1. A winglet comprising:
a winglet body comprising:
a first winglet surface arranged to face away from an attached wing; and
a second winglet surface arranged opposite the first winglet surface to face toward the attached wing, the second winglet surface joined to the first winglet surface to form a front edge of the winglet body and a trailing edge of the winglet body, the second winglet surface defining a control body seat; and
a control body coupled to the winglet body to move between a stowed position seated in the control body seat and a deployed position rotated out of the control body seat, the control body comprising:
a first control surface arranged to face toward the winglet body;
a second control surface arranged opposite the first control surface to face away from the winglet body and joined to the first control surface to form a trailing edge of the control body; and
a control front connecting the first control surface and the second control surface.

2. The winglet of claim 1, further comprising a hinge mounted at a junction of the control front and the first control surface, the hinge allowing rotation of the control body relative to the winglet body.

3. The winglet of claim 1, wherein when the control body is in the deployed position, the trailing edge of the control body is spaced from the trailing edge of the winglet body.

4. The winglet of claim 1, wherein when the control body is in the stowed position, the trailing edge the control body is substantially coincident with the trailing edge of the winglet body.

5. The winglet of claim 1, wherein when the control body is in the stowed position, the first control surface and the second winglet surface form a substantially continuous surface.

6. The winglet of claim 1, wherein when the control body is in the stowed position the second control surface is approximately adjacent to a chord line of the winglet body.

7. The winglet of claim 1, further comprising an actuator housed by the winglet body and configured to move the control body between the stowed position and the deployed position.

8. The winglet of claim 1, wherein the second winglet surface defines the control body seat as recess complementary to a size and shape of the control body, and when the control body is in the stowed position, the second control surface of the control body is substantially co-planar with the second winglet surface of the winglet body.

9. The winglet of claim 1, wherein the second winglet surface defines the control body seat rearward of the front edge of the winglet body and inside a chord line of the winglet body.

10. The winglet of claim 1, further comprising a solar panel disposed on one or more of the first winglet surface, the second winglet surface, or the second control surface.

11. A wing assembly comprising:
a wing having a proximal end and a distal end;
a winglet attached to the distal end of the wing, the winglet comprising:
a winglet body comprising:
a first winglet surface arranged to face away from the wing; and
a second winglet surface arranged opposite the first winglet surface to face toward the wing, the second winglet surface joined to the first winglet surface to form a front edge of the winglet body and a trailing edge of the winglet body, the second winglet surface defining a control body seat; and
a control body coupled to the winglet body to move between a stowed position seated in the control body seat and a deployed position rotated out of the control body seat and over the wing, the control body comprising:
a first control surface arranged to face toward the winglet body;
a second control surface arranged opposite the first control surface to face away from the winglet body and joined to the first control surface to form a trailing edge of the control body; and
a control front connecting the first control surface and the second control surface.

12. The wing assembly of claim 11, wherein winglet further comprises a hinge mounted at a junction of the control front and the first control surface, the hinge allowing rotation of the control body relative to the winglet body.

13. The wing assembly of claim 11, wherein when the control body is in the deployed position, the trailing edge of the control body is spaced from the trailing edge of the winglet body.

14. The wing assembly of claim 11, wherein when the control body is in the stowed position, the trailing edge the control body is substantially coincident with the trailing edge of the winglet body.

15. The wing assembly of claim 11, wherein when the control body is in the stowed position, the first control surface and the second winglet surface form a substantially continuous surface.

16. The wing assembly of claim 11, wherein when the control body is in the stowed position the second control surface is approximately adjacent to a chord line of the winglet body.

17. The wing assembly of claim 11, wherein the winglet further comprises an actuator housed by the winglet body and configured to move the control body between the stowed position and the deployed position.

18. The wing assembly of claim 11, wherein the second winglet surface defines the control body seat as recess complementary to a size and shape of the control body, and when the control body is in the stowed position, the second control surface of the control body is substantially co-planar with the second winglet surface of the winglet body.

19. The wing assembly of claim 11, wherein the second winglet surface defines the control body seat rearward of the front edge of the winglet body and inside a chord line of the winglet body.

20. The wing assembly of claim 11, wherein when the control body is in the deployed position, the control body and the trailing edge of the control body are located over the wing.

21. The wing assembly of claim 11, further comprising a solar panel disposed on one or more of the first winglet surface, the second winglet surface, or the second control surface.

22. The wing assembly of claim 11, wherein the wing defines a wing longitudinal axis and the winglet defines a winglet longitudinal axis, the winglet arranged with respect to the wing to have the winglet longitudinal axis substantially perpendicular to the wing longitudinal axis.
